(19) United States
(12) Patent Application Publication
(10) Pub. No.: US 2016/0379530 A1
(43) Pub. Date: Dec. 29, 2016

(54) Compression-Fit Digital Display Mounting System

(71) Applicant: David Lewis, Wantagh, NY (US)

(72) Inventor: David Lewis, Wantagh, NY (US)

(73) Assignee: Britework LLC, Wantagh, NY (US)

(21) Appl. No.: 14/751,419

(22) Filed: Jun. 26, 2015

(51) Int. Cl. G09F 7/18; F16B 2/00; F16C 3/03; F16M 13/02; F16B 2/04

(52) U.S. Cl. CPC G09F 7/18; F16M 13/02; F16B 2/04; F16C 3/03; F16B 2/005; G09F 2007/1856; G09F 2007/1873

(57) ABSTRACT

A digital display support system that is constructed using adjustable, telescoping support members and is secured into place using a compression force applied to the opposing mounting surfaces. This system can be used for supporting any type of digital display including, but not limited to: televisions, computer monitors, and LED/LCD displays. The support system forms a compression fit between opposing mounting surfaces precluding the need for additional fasteners or tools. The design is adjustable in the X, Y, and Z coordinates to install between various mounting surface dimensions and accommodates various display sizes and orientations.

### FIELD OF THE INVENTION

The present invention relates generally to digital display mounting systems, including those used by businesses for the purpose of promoting goods and/or services, and those used by consumers for home entertainment digital display mounting.

### BACKGROUND OF THE INVENTION

At the present time, in order to have an efficient and aesthetic digital display, an appropriate mounting apparatus is required to support the monitor. All of the commercially available digital display brackets must be mounted to a ceiling, wall, or floor in order to suspend the digital display, which requires a significant amount of expertise, effort, and capital to install.

The setup of these systems necessitates the use of various tools, which can cause a great deal of inconvenience and effort. To have the display professionally installed costs the owner a large sum of money. In addition, the bracket must be permanently affixed to a mounting surface which must typically be reinforced to properly support the applied weight.

Another common method to suspend a digital display is by use of a floor stand, which tends to take up valuable space and is subject to being disturbed or knocked over by a passerby. The aforementioned situation creates a serious safety hazard, putting both the individual(s) and costly equipment in harm's way.

Therefore, a device is required that has the following attributes: (1) able to be quickly assembled and installed without permanent mounting, (2) takes up no floor space and has minimal mass, (3) does not require tools or special skills to install, and (4) is adjustable in all dimensions to fit between any two mounting surfaces and to accommodate any display size. The current invention, Compression-Fit Digital Display Mounting System, an adjustable, compression-fit device, is the most effective approach to meet these requirements.

### SUMMARY OF THE INVENTION

The current invention is previously described as a digital display support system that is constructed using adjustable, telescoping support members and is secured into place using a compression force applied to the opposing mounting surfaces. This system can be used for supporting any type of digital display including, but not limited to: televisions, computer monitors, and LED/LCD displays. The support system forms a compression fit between opposing mounting surfaces precluding the need for additional fasteners or tools. The design is adjustable in the X, Y, and Z coordinates to install between various mounting surface dimensions and accommodates various display sizes and orientations (refer to Abstract).

The support system members can be adjusted to fit within the mounting surfaces by sliding them into position and forming a compression-fit. The structural members can be made of various materials including, but not limited to: Steel, aluminum, plastic, composites, and wood. In addition, the support members can be constructed in the form of various cross-sectional geometries such as squares (or any parallelogram geometry), circles (or any round geometry), triangles, “L” shaped configurations, or “I” shaped configurations. The support system members can slide into position and then be secured into place using various locking or fastener technologies.

A compression method is applied that forces apart the support members to tightly fit between the mounting surfaces. Such compression methods can include: (1) A spring system that forces the support members apart to compress between the mounting surfaces, (2) a screw-type device (jackscrew, ratchet mechanism, adjustable leveling feet) that is in contact with the support members and forces them apart when adjusted, (3) a ratchet mechanism that forces the support members apart to form a positive compression force with the mounting surfaces, (4) an air bladder system that forces the support members apart when inflated, or (5) a frictional lever that uses a lever with a frictional surface that engages with the support members to force them apart.

An additional contact mechanism for the mounting surfaces can be used, which would extend the contact-surface area, thereby increasing the frictional force and protecting the mounting surfaces from damage by direct physical contact with the support members. The contact mechanism can also prevent the support system from slipping out of position by these means: The frictional force can be provided via a rubberized surface, double-sided adhesive tape, Velcro, or other adhesives and mounting types.

The digital display is affixed to the support system cross member, which includes a mounting-hole pattern to accommodate various displays that can be hung in a landscape or portrait orientation. In addition, multiple cross members can be added, which would allow multiple digital displays to be affixed to one support system. The spacing between the horizontal and vertical support members can be adjusted to accommodate multiple digital display sizes.

### BRIEF DESCRIPTION OF THE DRAWINGS

FIG. 1 depicts a rear isometric view of the fully assembled Digital Display Mounting System. It illustrates the system installed between two (2) mounting surfaces using positive forces invoked by a compression mechanism. The frame of the structure is comprised of a series of vertical members made of telescoping tubing or other geometric cross sectional designs, which is adjusted to fit between the mounting surfaces. The contact surfaces between the vertical members and the mounting surfaces can include a material which provides for additional frictional force and adhesion that prevents slippage between the apparatus and the mounting surfaces. The horizontal cross members are constructed to allow for width adjustment to accommodate various display system monitor sizes and orientations. In addition, they can be adjusted and offset to ensure a flush mount between the vertical member and the display system surfaces. This is particularly important in that it allows the display system to be in close proximity to a storefront/display window in order to optimize the luminescence transmission of the display through the glass medium. Once the appropriate dimensional adjustment is attained, the mechanism can be secured rigidly into place using a fastening and/or locking system. This design can accommodate the installation of multiple horizontal cross members that can support multiple display systems. The design of the vertical and horizontal members can include an aesthetically pleasing wire management system that allows for the routing of electrical and connection wiring of the display system.

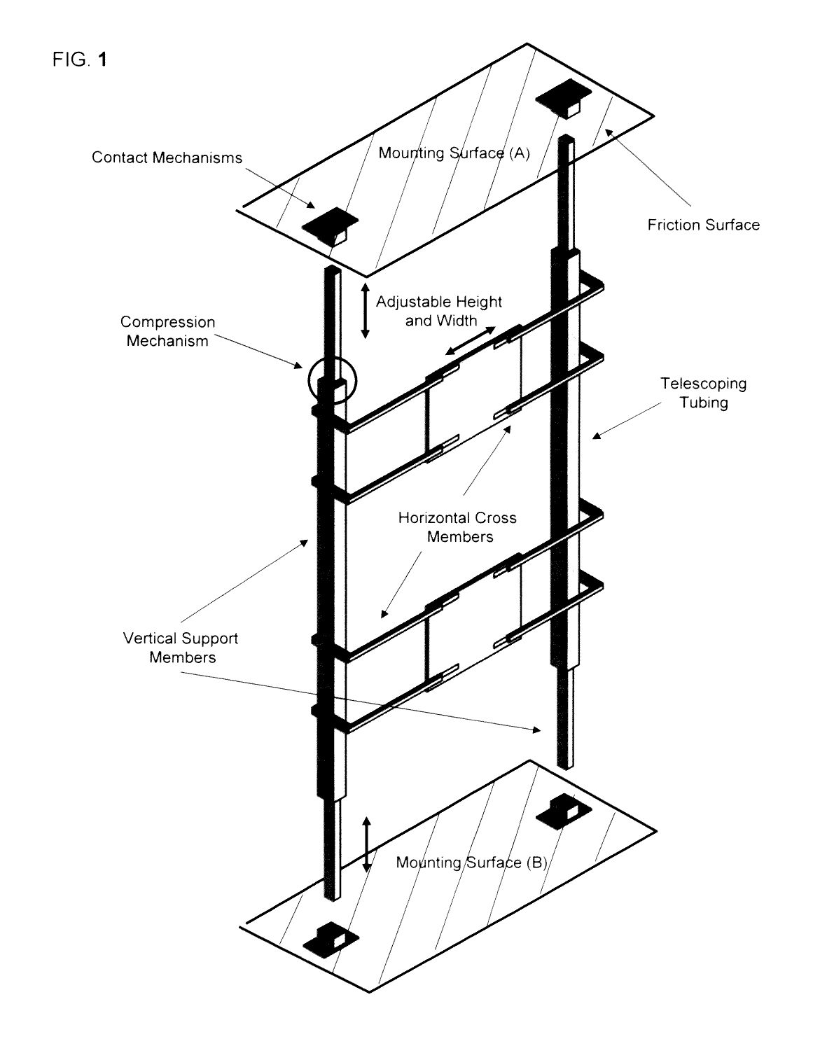

FIG. 2 depicts a frontal isometric view of the fully assembled Digital Display Mounting System in FIG. 1. Once again, this illustration shows the vertical adjustments that can be made to fit between any mounting surface height using a compression fit.

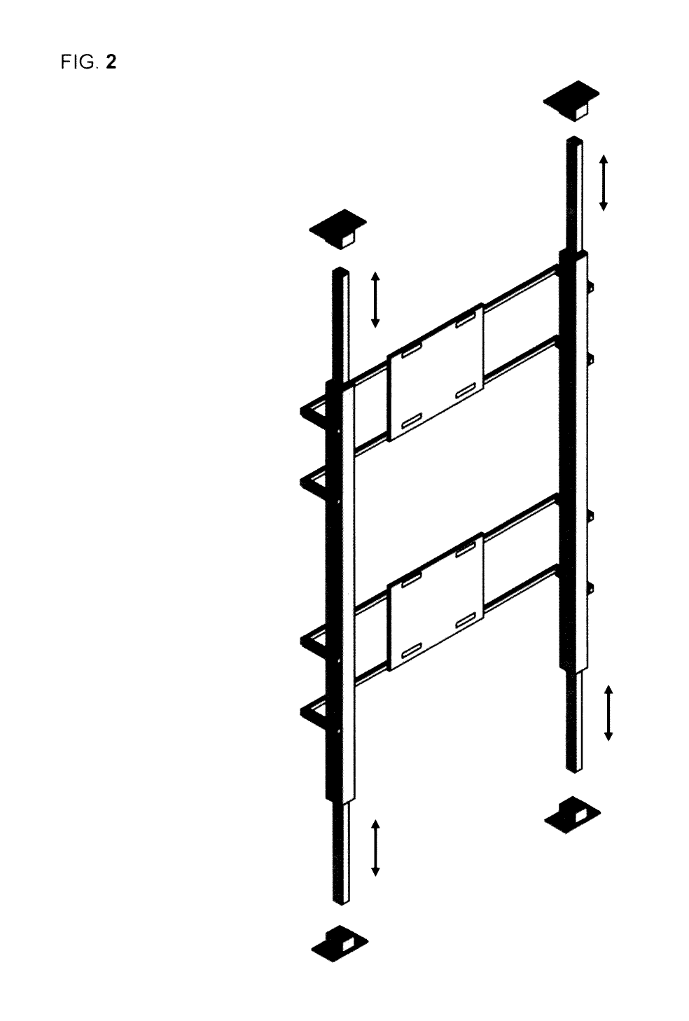

FIG. 3 is a frontal isometric illustration depicting two (2) display system monitors in a flush-mount with the apparatus surface (Landscape). The amount of displays attached to the system can vary. The depth of the horizontal support members can be adjusted to a viable depth to accommodate the display thickness and allow for flush mounting.

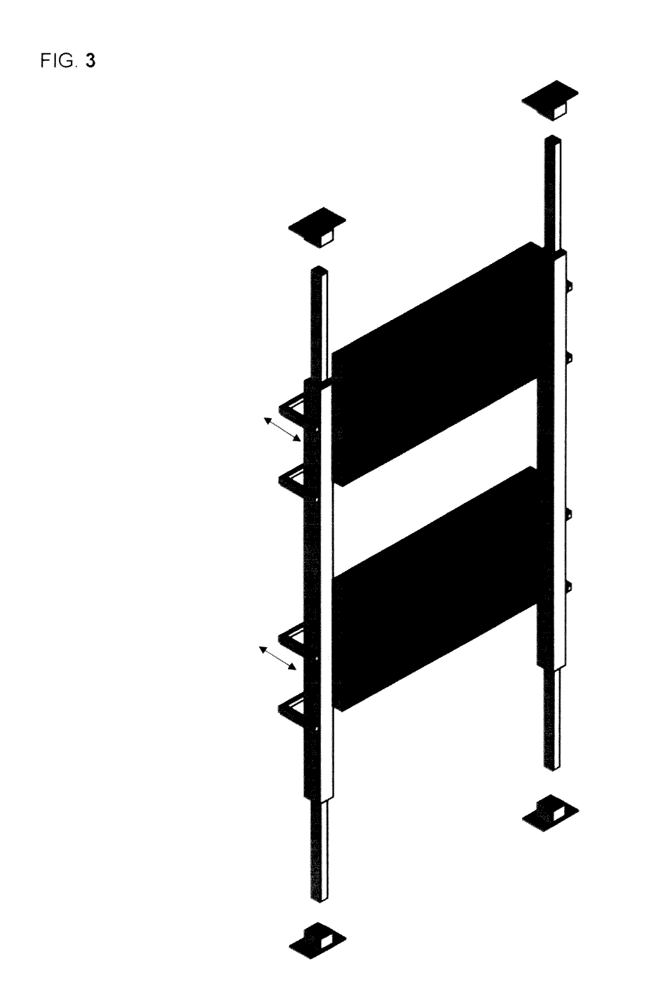

FIG. 4 is a frontal isometric illustration depicting one (1) display system monitor in a flush mount with the apparatus surface (Portrait). The display system can be installed in a portrait or landscape orientation, necessitating the need for adjustability of the horizontal support members, as shown.

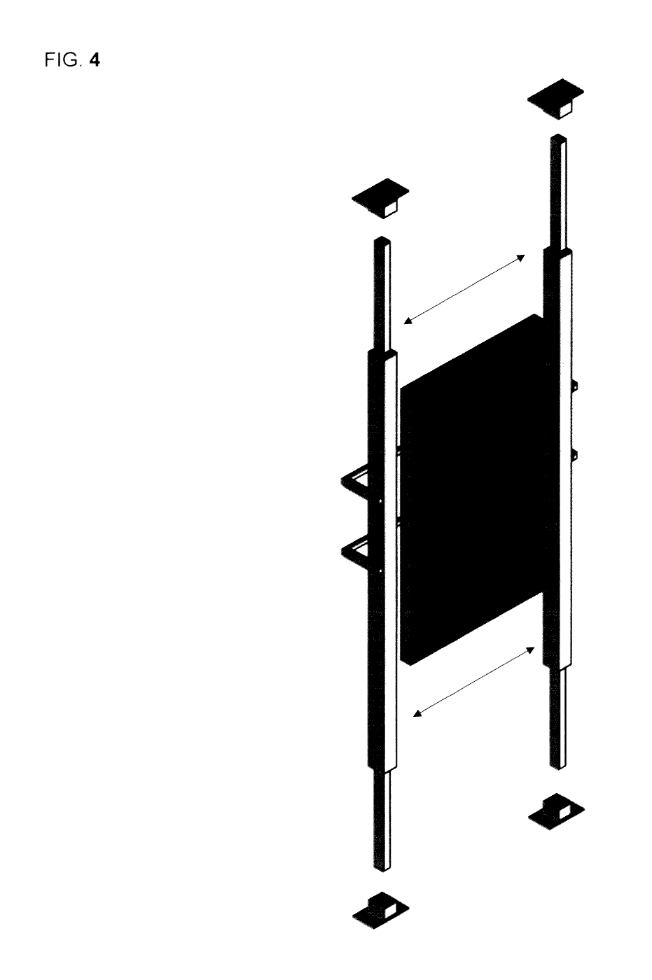

FIG. 5 illustrates a particular application of the fully assembled apparatus, with two (2) display screens installed in a storefront window frame wherein the displays are flush-mount in close proximity to the glass surface for optimal light transmission and viewing effectivity.

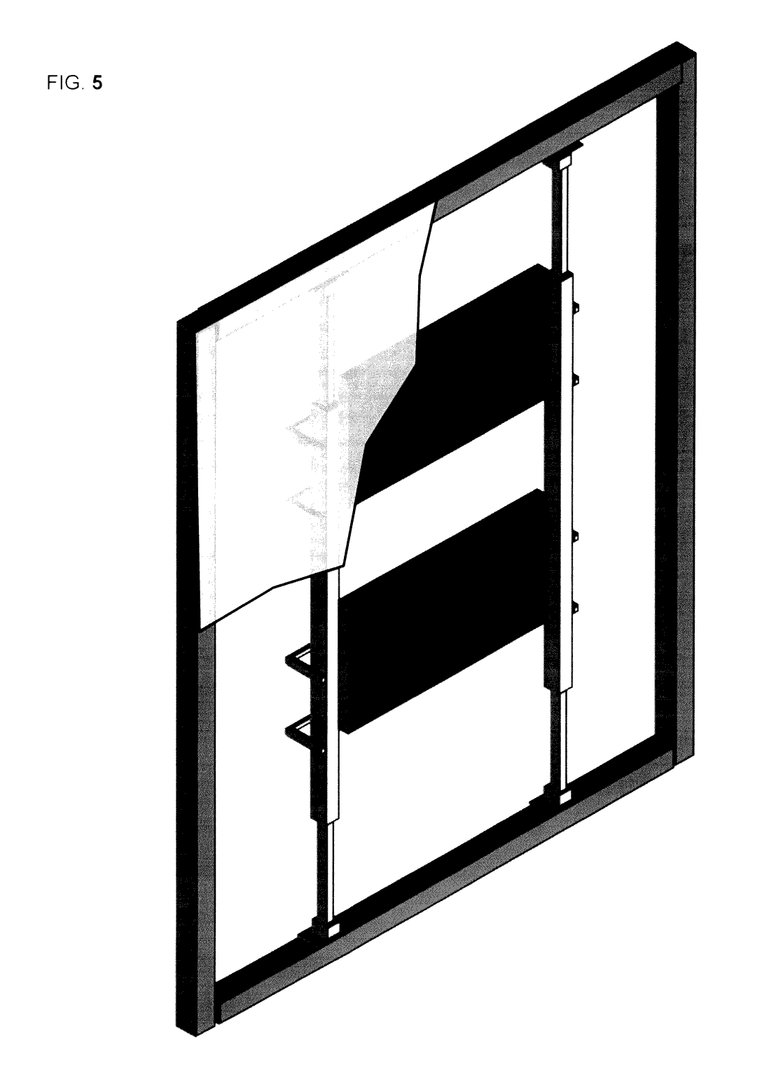

FIG. 6 depicts another particular application of the fully assembled apparatus with two (2) display screens installed on the system between a floor and a ceiling.

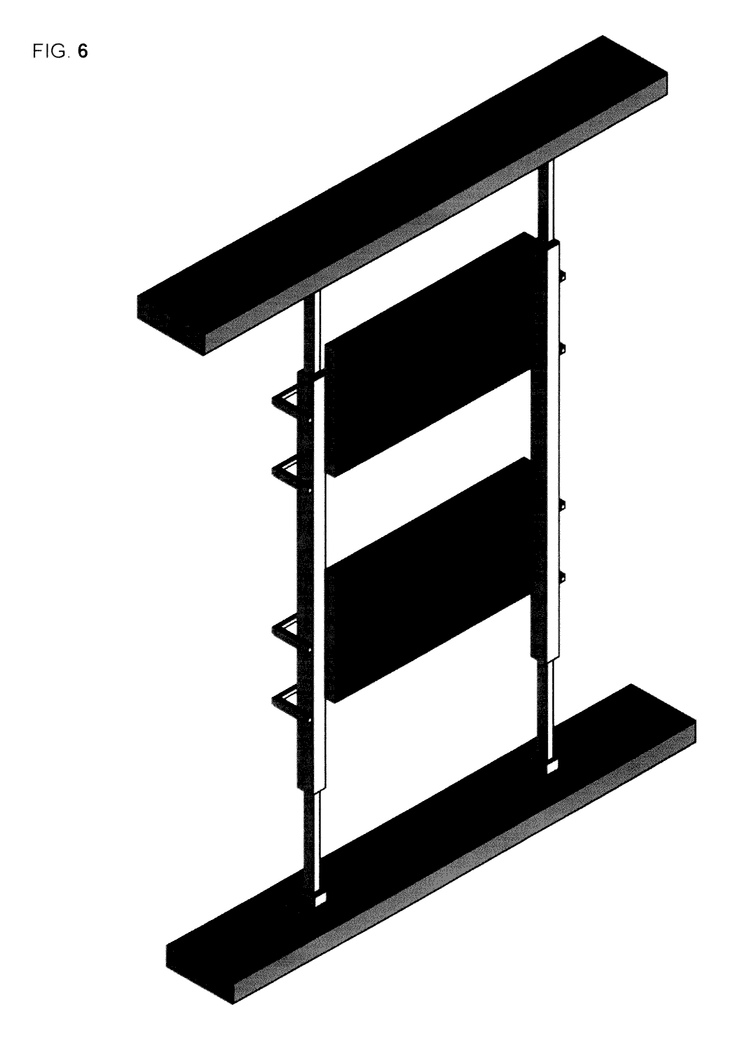

FIG. 7 shows the compression mounting system installed along the horizontal axis between two vertical structures such as walls and/or within a window frame.

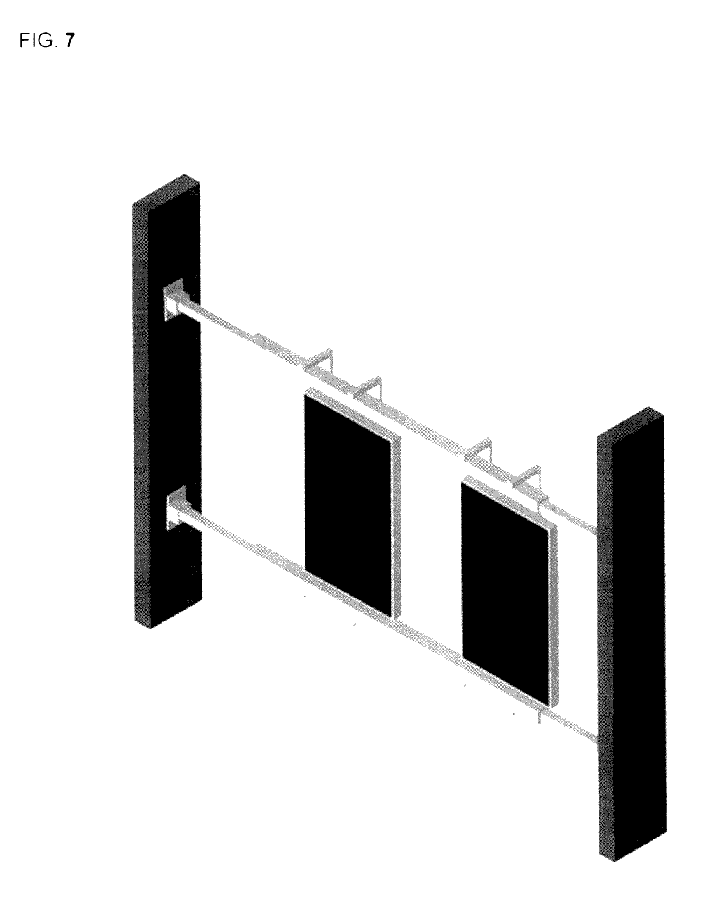

What is claimed is:

I. A “Compression-Fit Digital Display Mounting System,” which can be easily installed between two opposing mounting surfaces using a positive force of compression and friction thereby precluding the use of tools, fasteners, or special skills for installation.

II. This system is adjustable in all three dimensions, accommodating various mounting surface dimensions and digital display monitor sizes and orientations, thus allowing one or more monitors, such as television screens or LCD/LED displays to be securely attached to the system.

III. This system can be used in both commercial and consumer applications. It is especially useful for business advertising purposes, allowing for close-proximity installation between the viewing surface of the digital display and a storefront window resulting in optimal visual clarity.
